(19) United States
(12) Patent Application Publication
(10) Pub. No.: US 2010/0227602 A1
(43) Pub. Date: Sep. 9, 2010

(54) SYSTEM AND METHOD FOR MANAGING MOBILE PHONE RING TONE PROFILES

(75) Inventor: MIN-YAN ZHANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/612,748

(22) Filed: Nov. 5, 2009

(30) Foreign Application Priority Data
Mar. 7, 2009 (CN) 200910300747.8

(51) Int. Cl. H04M 3/00

(52) U.S. Cl. 455/418; 455/567

(57) ABSTRACT

A system and method for managing mobile phone ring tone profiles sets a first ring tone profile, a second ring tone profile, and a trigger value. If a phone number of an incoming call or an incoming message exists in a contact list of the mobile phone, or if the phone number exists in a call log and a communicate count of the phone number is more than the trigger value, the first ring tone profile is selected as a current ring tone profile of the mobile phone. If the phone number does not exist in the contact list and the call log, or if the phone number exists in the call log but the communicate count of the phone number in the call log is not more than the trigger value, the second ring tone profile is selected.

### BACKGROUND

1. Technical Field

Embodiments of the present disclosure relate to mobile phone ring tones, and more particularly to a system and method for managing phone ring tone profiles of a mobile phone.

2. Description of Related Art

Mobile phone ring tones may disturb someone during a meeting or when a person is asleep. At present, a ringer of a mobile phone may be switched off or placed into a silent and/or a vibration mode to silence the mobile phone. However, an important call or message may be missed when in the mobile phone is in the silent mode and/or the vibration mode.

What is needed, therefore, is an improved system and method for managing phone ring tone profiles.

### BRIEF DESCRIPTION OF THE DRAWINGS

FIG. 1 is a block diagram of one embodiment of a system for managing mobile phone ring tone profiles.

FIG. 2 is a block diagram of functional modules of the managing system in FIG. 1.

FIG. 3 is a flowchart of one embodiment of a method for managing mobile phone ring tone profiles.

### DETAILED DESCRIPTION

All of the processes described below may be embodied in, and fully automated via, functional modules executed by one or more general purpose processors. The functional modules may be stored in any type of computer-readable medium or other computer storage device. Some or all of the methods may alternatively be embodied in specialized computer hardware or communication apparatus.

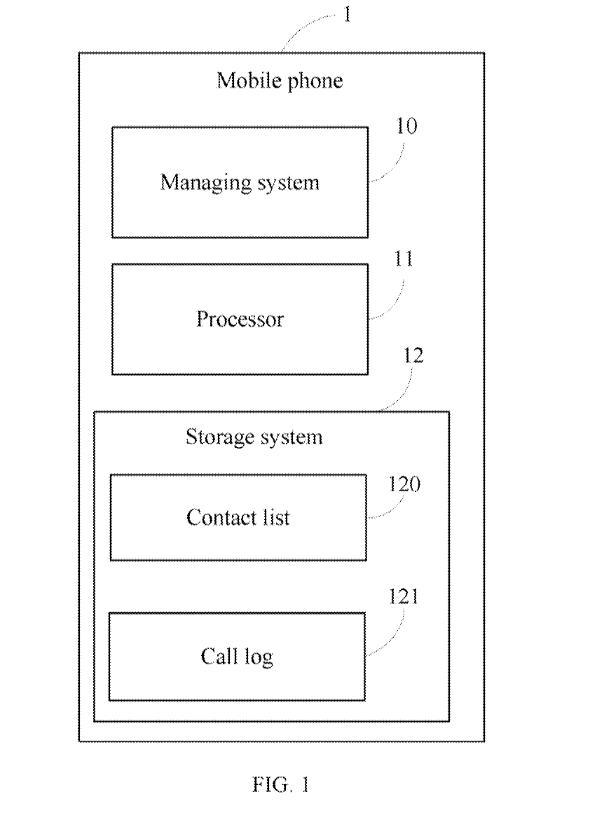

FIG. 1 is a block diagram of one embodiment of a mobile phone 1 comprising a managing system 10. The managing system 10 may be used to provide a switch function used to switch ring tone profiles of the mobile phone 1. The mobile phone 1 includes a processor 11 and a storage system 12. The processor 11 executes one or more computerized operations of the mobile phone 1 and other applications, to provide the functions of the mobile phone 1. The storage system 12 stores one or more programs, such as programs of an operating system, other applications of the mobile phone 1, and various kinds of data, such as personalized function settings and original settings of the function settings of the mobile phone 1, messages, or E-mails, for example. A contact list 120 and a call log are stored in the storage system 12. The contact list 120 lists contact names, phone numbers, E-mail addresses of contacts, for example. In one embodiment, the call log 121 may record outgoing call information, answered call information, and missed call information.

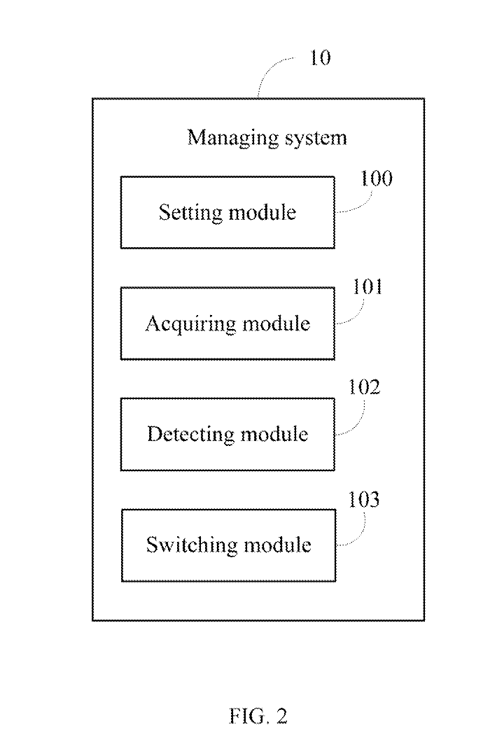

FIG. 2 is a block diagram of functional modules of the managing system 10 in FIG. 1. In one embodiment, the managing system 10 may include a setting module 100, an acquiring module 101, a detecting module 102, and a switching module 103. It may be understood that the processor 11 may be used to execute one or more computerized codes of the functional modules 100-103. The one or more computerized codes of the functional modules 100-103 may be stored in the storage system 12.

The setting module 100 provides a user interface of the mobile phone 1 for setting a start time to enable the switch function, an end time to disable the switch function, a first ring tone profile, and a second ring tone profile. The ring tone profiles correspond to a ring mode of the mobile phone. For example, in one embodiment, the first ring tone profile may be selected by a user if a familiar phone number is received by the mobile phone 1. The second ring tone profile may be selected by the user if a strange phone number is received by the mobile phone 1. The first ring tone profile may be set in a crescendo mode. The second ring tone profile may be set in a mute mode. The mute mode may include a silent mode and/or a vibrate mode. The user interface may be displayed on a display of the mobile phone 1.

The setting module 100 further presets a trigger value. The trigger value is a numerical value used to detect if an incoming phone number is the familiar phone number or the strange phone number. The trigger value is compared with a communication count of a specified phone number. In one embodiment, the trigger value may be three. For example, if a communicate count of the incoming phone number in the call log 121 is less than three, the incoming phone number is determined as the strange phone number. If the communicate count of the incoming phone number in the call log 121 is not less than three, the incoming phone number is determined as the familiar phone number.

The acquiring module 101 reads a phone number of an incoming call or an incoming message.

The detecting module 102 detects if a system time of the mobile phone 1 has reached the start time. If the system time of the mobile phone 1 has not reached the start time, a current ring tone profile of the mobile 1 is maintained. If the system time of the mobile phone 1 has reached the start time, the detecting module 102 further detects if the read phone number exists in the contact list 120. If the read phone number exists in the contact list 120, the switching module 103 selects the first ring tone profile as the current ring tone profile.

If the read phone number does not exist in the contact list 120, the detecting module 102 searches the call log 121 for the read phone number and counts the communicate count of the read phone number. If the read phone number is found in the call log 121 and repeated in the call log 121 at least the trigger value, the switching module 103 stores the current ring tone profile into the storage system 12, and selects the first ring tone profile as the current ring tone profile. If the read phone number is not in the call log 121 or if the read phone number is found in the call log 121 but the communicate count of the read phone number is less than the trigger value, the switching module 103 stores the current ring tone profile into the storage system 12 and selects the second ring tone profile as the current ring tone profile.

If the end time has arrived, the switching module 103 switches the first or second ring tone profile back to the ring tone profile stored in the storage system 12.

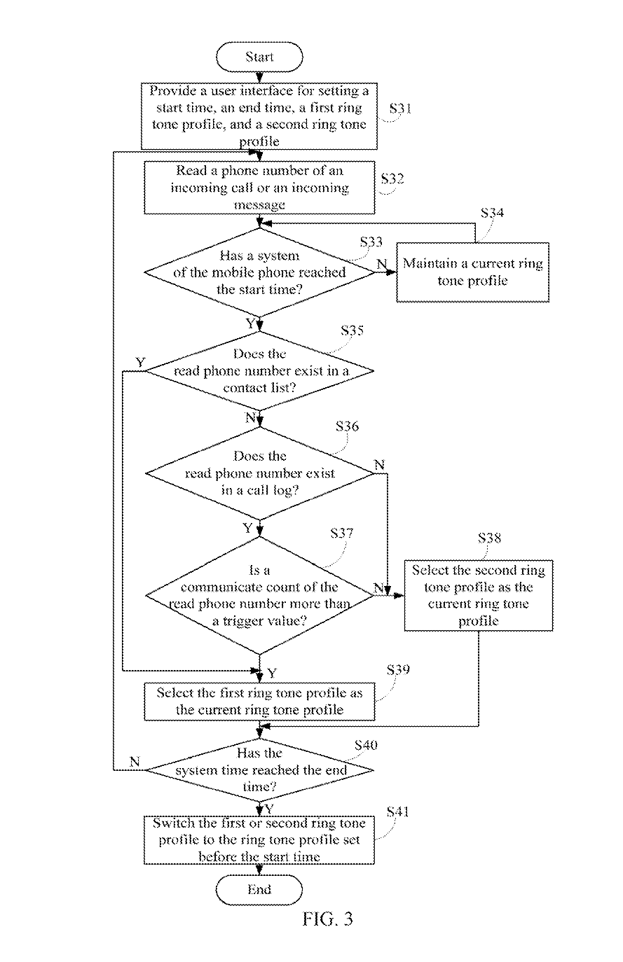

FIG. 3 is a flowchart of one embodiment of a method for managing mobile phone ring tone profiles. Depending on the embodiment, additional blocks may be added, others removed, and the ordering of the blocks may be changed.

In block S31, the setting module 100 provides a user interface of the mobile phone 1 for setting a start time and an end time enable and disable the switch function, a first ring tone profile and a second ring tone profile. The setting module 100 also presets a trigger value to compare with a communicate count of a specified phone number.

In block S32, the acquiring module 101 reads a phone number of an incoming call or an incoming message.

In block S33, the detecting module 102 detects if a system time of the mobile phone 1 has reached the start time. If the system time of the mobile phone 1 has reached the start time, block S35 is implemented. If the system time of the mobile phone 1 has not reached the start time, in block S34, the current ring tone profile maintains, and block S33 is repeated.

In block S35, the detecting module 102 detects if the read phone number exists in the contact list 120. If the read phone number exists in the contact list 120, block S39 is implemented. If the read phone number does not exist in the contact list 120, block S36 is implemented.

In block S36, the detecting module 102 detects if the read phone number exists in the call log 121. If the read phone number exists in the call log 121, block S37 is implemented. If the read phone number does not exist in the call log 121, block S38 is implemented.

In block S37, the detecting module 102 counts the communicate count of the read phone number in the call log 121, and detects if the communicate count of the read phone number in the call log 121 is more than the trigger value. If the communicate count of the read phone number is not more than the trigger value, in block S38, the switching module 103 stores the current ring tone profile into the storage system 12, and selects the second ring tone profile as the current ring tone profile. If the communicate count of the read phone number is more than the trigger value, in block S39, the switching module 103 stores the current ring tone profile into the storage system 12, and selects the first ring tone profile as the current ring tone profile.

In block S40, the detecting module 102 detects if the system time of the mobile phone 1 has reached the end time. If the system time has reached the end time, in block S41, the switching module 103 switches the first or second ring tone profile back to the ring tone profile stored in the storage system 12. If the system time has not reached the end time, block S32 is repeated.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for managing phone ring tone profiles, the system comprising:
a storage system; and
at least one processor to execute one or more programs stored in the storage system, the one or more programs comprising:
a setting module operable to provide a user interface for the system for setting a start time and an end time to enable and disable a switch function, a first ring tone profile of the system and a second ring tone profile of the system;
an acquiring module operable to read a phone number of an incoming call or an incoming message;
a detecting module operable to detect if the read phone number exists in a contact list of the system if a system time of the system has reached the start time;
a switching module operable to select the first ring tone profile as a current ring tone profile of the system if the read phone number exists in the contact list;
the detecting module also operable to detect if the read phone number exists in a call log of the system if the read phone number does not exist in the contact list; and
the switching module further operable to select the first ring tone profile as the current ring tone profile if the read phone number exists in the call log.

2. The system of claim 1, wherein the setting module is further operable to preset a trigger value to compare with a communicate count of the read phone number in the call log.

3. The system of claim 2, wherein the detecting module is further operable to count the communicate count of the read phone number, and the switching module is further operable to selects the second ring tone profile as the current ring tone profile if the read phone number does not exist in the call log or if the communicate count of the read phone number is not more than the trigger value.

4. The system of claim 1, wherein the switching module is further operable to switch the first or second ring tone profile to the ring tone profile which is set before the start time when the system time of the system has reached the end time.

5. The system of claim 1, wherein the first ring tone profile is set in a crescendo mode.

6. The system of claim 1, wherein the second ring tone profile is set in a mute mode.

7. A method for managing phone ring tone profiles, the method comprising:
(a) providing a user interface for a mobile phone, the user interface configured for setting a start time and an end time to enable and disable a switch function, a first ring tone profile of the mobile phone and a second ring tone profile of the mobile phone;
(b) reading a phone number of an incoming call or an incoming message;
(c) detecting if the read phone number exists in a contact list of the mobile phone if a system time of the mobile phone has reached the;
(d) selecting the first ring tone profile as a current ring tone profile if the read phone number exists in the contact list;
(e) detecting if the read phone number exists in a call log of the mobile phone if the read phone number does not exist in the contact list;
(f) selecting the first ring tone profile as the current ring tone profile of the mobile phone if the read phone number exists in the call log.

8. The method of claim 7, wherein block (a) comprises: presetting a trigger value to compare with a communicate count of the read phone number in the call log.

9. The method of claim 8, further comprising:
counting the communicate count of the read phone number; and
selecting the second ring tone profile as the current ring tone profile if the read phone number does not exist in the call log or if the communicate count of the read phone number is not more than the trigger value.

10. The method of claim 7, further comprising: switching the first or second ring tone profile to a ring tone profile which is set before the start time when the system time of the mobile phone has reached the end time.

11. The method of claim 7, wherein the first ring tone profile is set in a crescendo mode.

12. The method of claim 7, wherein the first ring tone profile is set in a mute mode.

13. A computer readable medium having stored therein instructions that, when executed by a mobile phone, cause the mobile phone to perform a method for managing mobile phone ring tone profiles, the method comprising:
(a) providing a user interface for a mobile phone, the user interface configured for setting a start time and an end time to enable and disable a switch function, a first ring tone profile of the mobile phone and a second ring tone profile of the mobile phone;
(b) reading a phone number of an incoming call or an incoming message;
(c) detecting if the read phone number exists in a contact list of the mobile phone if a system time of the mobile phone has reached the;
(d) selecting the first ring tone profile as a current ring tone profile if the read phone number exists in the contact list;
(e) detecting if the read phone number exists in a call log of the mobile phone if the read phone number does not exist in the contact list;
(f) selecting the first ring tone profile as the current ring tone profile of the mobile phone if the read phone number exists in the call log.

14. The medium of claim 13, wherein block (a) comprises: presetting a trigger value to compare with a communicate count of the read phone number in the call log.

15. The medium of claim 14, further comprising:
counting the communicate count of the read phone number; and
selecting the second ring tone profile as the current ring tone profile if the read phone number does not exist in the call log or if the communicate count of the read phone number is not more than the trigger value.

16. The medium of claim 13, further comprising: switching the first or second ring tone profile to a ring tone profile which is set before the start time when the system time of the mobile phone has reached the end time.

17. The medium of claim 13, wherein the first ring tone profile is set in a crescendo mode.

18. The method of claim 13, wherein the first ring tone profile is set in a mute mode.
